(19) United States
(12) Patent Application Publication
(10) Pub. No.: US 2018/0213972 A1
(43) Pub. Date: Aug. 2, 2018

(54) Glass Lid Fixing Structure with Spring Loaded Pinball Arrangement for Cooking Pot

(71) Applicant: Wood Yik LAM, Hong Kong (HK)

(72) Inventor: Wood Yik LAM, Hong Kong (HK)

(21) Appl. No.: 15/421,276

(22) Filed: Jan. 31, 2017

(51) Int. Cl. A47J 36/10; A47J 36/08; A47J 36/02; E05C 3/14

(52) U.S. Cl. CPC A47J 36/10; A47J 36/08; E05Y 2900/602; E05C 3/145; A47J 36/02

(57) ABSTRACT

The present invention discloses a cooking pot's glass lid fixing structure with a spring loaded pinball arrangement of a cooking pot is rotatable and fixed on top side of the cooking pot handle. A hole which has a pinball connected to a loading spring ins installed on a location corresponding to the slot at the top side of the cooking pot handle so that the slot will engage with the pinball. When the lock is rotated 180° from a rest position, it can then hold down the glass lid firmly onto the cooking pot. The cooking pot's glass lid fixing structure with spring loaded pinball arrangement of the present invention is simple and it provides a quick and easy solution to firmly hold down the glass lid onto the cooking pot.

### BACKGROUND OF THE PRESENT INVENTION

### Field of Invention

The present invention discloses a glass lid locking structure with spring loaded pinball lock design for cooking pot.

### Description of Related Arts

Conventional glass lid and cooking pot usually lacks a locking mechanism that fixes the lid towards the pot. Water straining for cooking pot will require the lid to be closed and tilted to dispense the water. The lid will fall off when this happens. It is inconvenient if the cooking pot and lid needs to be held together by hand during water straining when the lid is hot.

### SUMMARY OF THE PRESENT INVENTION

The glass lid locking structure with spring loaded pinball design for cooking pot of the present invention is simple and it provides a quick and easy solution to firmly hold down the glass lid onto place.

In order to solve the above mentioned objectives, the present invention discloses:

A glass lid fixing structure with spring loaded pinball design of cooking pot comprising; a lock, wherein the lock is rotatable and fixed on the top side of a cooking pot handle, wherein a pinball with loading spring is installed on bottom side of the lock symmetrically, wherein the cooking pot handles have slot that are located corresponding to the pinball of the lock, wherein the slot of the cooking pot handle can engage with the pinball at rest position, wherein when the lock is rotated 180° from a rest position, the lock can then hold down the glass lid firmly onto the cooking pot.

Furthermore, the lock is semicircle in shape.

Furthermore, the lock has a hole which is conical in shape for installing the loading spring and the pinball in order.

Furthermore, the loading spring is fixed inside the hole of the lock by a spring fixing screw through one end which is opposite to the lock.

Furthermore, the slot has a size and shape complementary to the pinball for coupling with the pinball. Preferably, the slot is a semicircle slot for coupling with the pinball.

Furthermore, the pinball is a steel pinball which is made of steel.

Furthermore, the handle of the cooking pot is fixed onto the cooking pot by a handle fixing screw and a silica gel insulating ring is positioned between the handle of the cooking pot and the cooking pot.

Furthermore, a stainless steel insulating ring is also provided between the handle of the cooking pot and the cooking pot.

Furthermore, a stainless steel insulating ring is provided between the silica gel insulating ring and the handle of the cooking pot.

Furthermore, the lock is mounted onto the handle of the cooking pot by a rivet. The lock can rotate in axle fashion from the rivet. Preferably, the lock can rotate about the rivet and the rivet is the axle.

Compared to the conventional prior arts, the present invention has the following advantageous effect: the structure is simple and is easy to use while the cost is low. When the lock is rotated 180° from a rest position, the pair of slots from the handle of the cooking pot will disengage with the pinball from the lock via the loading spring, and then the lock will hold down the glass lid firmly onto the cooking pot. An additional rotation of 180° (at either direction) will allow the coupling of pinball to engage the slots of the handle of the cooking pot via the loading spring, this will unlock the glass lid so it can be taken off from the cooking pot.

### BRIEF DESCRIPTION OF THE DRAWINGS

FIG. 1 of the drawings illustrates the glass lid fixing structure with spring loaded pinball arrangement for cooking pot according to the present invention.

FIG. 2 of the drawings illustrates a cross section of section A-A of the glass lid fixing structure with spring loaded pinball arrangement for cooking pot according to the present invention.

FIG. 3 of the drawing illustrates a cross section of section B-B of the glass lid fixing structure with spring loaded pinball arrangement for cooking pot according to the present invention.

FIG. 4 of the drawings illustrates a flow diagram of operation of the glass lid fixing structure with spring loaded pinball arrangement for cooking pot.

### DETAILED DESCRIPTION OF THE PREFERRED EMBODIMENT

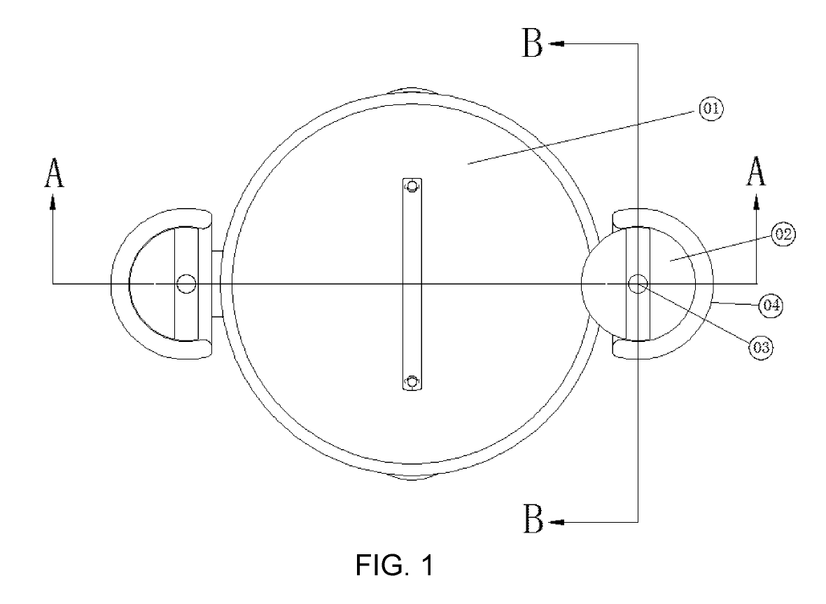

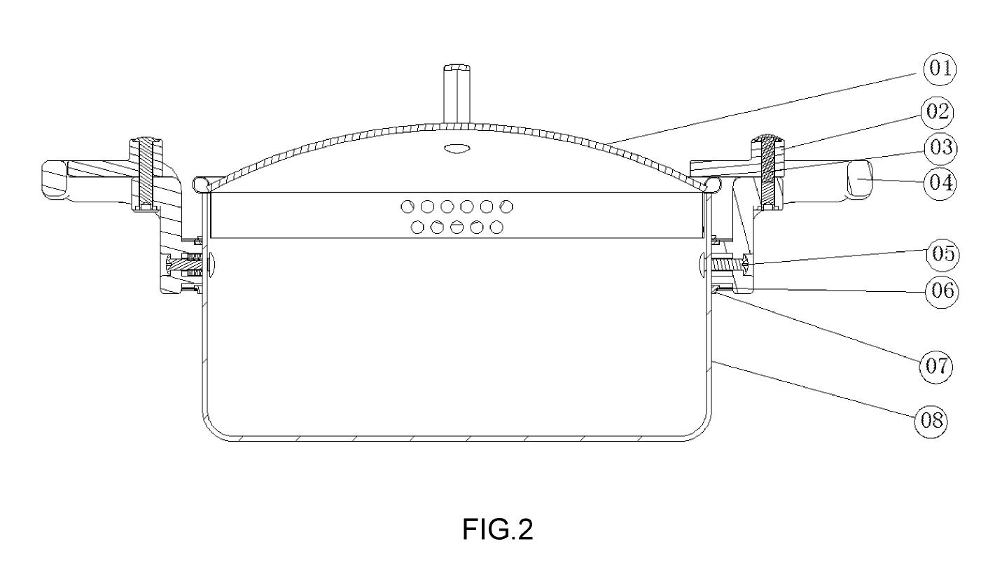

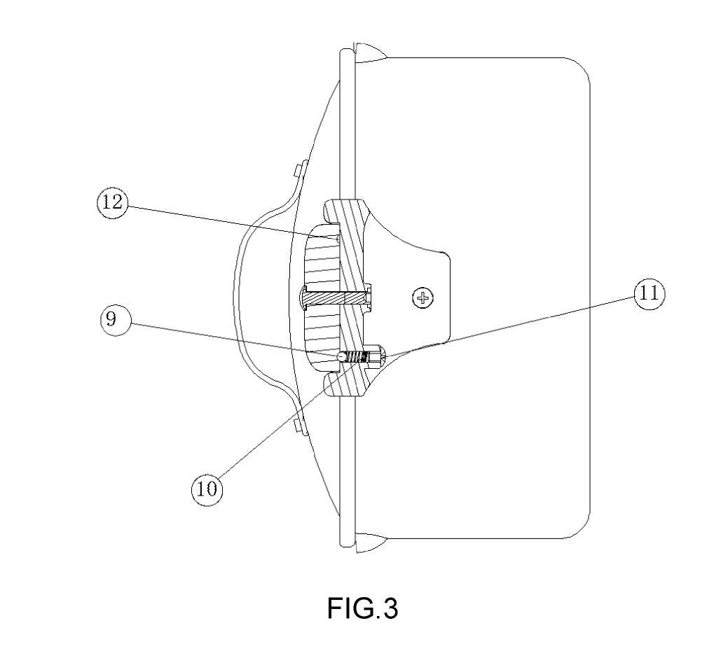

Referring to FIGS. 1-3 of the drawings, a glass lid fixing structure with spring loaded pinball arrangement for cooking pot of the present invention is illustrated. The glass lid fixing structure with spring loaded pinball arrangement for cooking pot comprises a lock 2 which is semicircle in shape. The lock 2 is rotatable and fixed by a rivet 3 on a top side of a handle 4 of the cooking pot. (The rivet 3 serves as the axis for rotation). From the bottom of the lock 2, there is a pinball installed with a loaded spring. The slot 12 is shaped with recess cavity with respect to the pinball 9.

The loading spring 10 is fixed inside the hole of the lock 2 by a spring fixing screw through one end which is opposite to the lock 2. The slot 12 couples with the pinball 9 respectively such that when the lock 2 is rotated 180° from a rest position, the lock 2 can then hold down the glass lid 1 firmly onto the cooking pot 8.

Preferably, the slot is a semicircle slot and the pinball is a circular in shape.

The lock 2 in the rest position does not engage the glass lid 1. After rotating the lock 2 in a predetermined angle to reach a locking position, the lock 2 will engage the glass lid 1 to press against it so that the glass lid 1 is firmly locked in place. By continuing the rotation of the lock 2 from the locking position in a predetermined angle, the lock 2 will then disengage the glass lid 1. The lock 2 may be in any tangible shape as long as the rotation of the lock 2 allows the user to select the rest position or the locking position.

The handle 4 of the cooking pot is fixed onto the cooking pot 8 by a handle fixing screw 5. A silica gel insulating ring 6 is inserted between the handle 4 of the cooking pot and the cooking pot 8. A stainless steel insulating ring 7 is also inserted between the handle 4 of the cooking pot and the cooking pot 8. The stainless steel insulating ring is inserted between the silica gel insulating ring 6 and the handle 4 of the cooking pot.

The steps of utilizing the present invention are as follows:

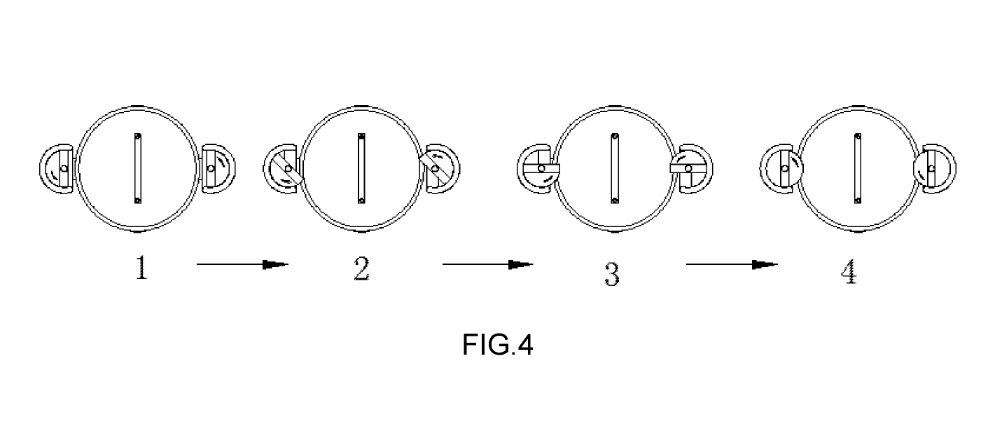

According to FIG. 4 of the drawings, when the lock 2 is rotated to a position as shown in the first step, the spring loaded pinball 9 is on the bottom side of the lock 2 which can couple with the slot 12 of the cooking pot handle via the loading spring 10 thus fixing the lock with the cooking pot handle at rest position. When lock 2 is used to lock the glass lid 1 at locking position, the lock 2 is rotated by 180° to engage the glass lid 1 shown in step 4.

The cooking pot handle slots 12 which is located on top will engage with the pinball 9 of the lock via the loaded spring 10.

The spring loaded pinball moves vertically to fix the lock against the cooking pot handle 4 by having the pin ball 9 of the lock 2 to engage the slot 12 of the cooking pot handle 4. This is the rest position. In the locking position the semicircle shaped lock 2 will press against the glass lid 1 so that the glass lid 1 is secured into position on the cooking pot. In this configuration, the liquid or article stored inside the cooking pot 8 may be poured out via an opening of the cooking pot without taking off the glass lid 1. This technique of pouring with glass lid on is commonly known as ‘straining’.

The above detailed description of the preferred embodiment is the preferred mode of carrying out the invention. The description is not to be taken in any limiting sense. It is presented for the purpose of illustrating the general principles of the present invention.

What is claimed is:

1. A glass lid fixing structure with spring loaded pinball arrangement of a cooking pot comprising: a lock, wherein the lock is rotatable and is fixed on a top side of a handle of the cooking pot, wherein a slot is located on the top side of the handle of the cooking pot, wherein a spring loaded pinball is fixed on a bottom side of the lock, wherein the slot and the pinball engage for rest position, wherein when the lock is rotated 180° from the rest position, the lock can then hold down the glass lid firmly onto the cooking pot.

2. The glass lid fixing structure with spring loaded pinball arrangement of a cooking pot as recited in claim 1, wherein the lock is semicircle in shape.

3. The glass lid fixing structure with spring loaded pinball arrangement of a cooking pot as recited in claim 1, wherein the hole is conical in shape for receiving the loading spring and the pinball in order.

4. The glass lid fixing structure with spring loaded pinball arrangement of a cooking pot as recited in claim 1, the loading spring is fixed inside the hole of the lock by a spring fixing screw through one end which is opposite to the lock.

5. The glass lid fixing structure with spring loaded pinball arrangement of a cooking pot as recited in claim 3, the loading spring is fixed inside the hole of the lock by a spring fixing screw through one end which is opposing to the lock.

6. The glass lid fixing structure with pinball arrangement for cooker as recited in claim 1, wherein the pinball is a steel pinball made of steel.

7. The glass lid fixing structure with spring loaded pinball arrangement of a cooking pot as recited in claim 1, wherein the handle of the cooking pot is fixed onto the cooking pot by a handle fixing screw, wherein a silica gel insulating ring is positioned between the handle of the cooking pot and the cooking pot.

8. The glass lid fixing structure with spring loaded pinball arrangement of a cooking pot as recited in claim 7, wherein a stainless steel insulating ring is positioned between the handle of the cooking pot and the cooking pot.

9. The glass lid fixing structure with spring loaded pinball arrangement of a cooking pot as recited in claim 8, wherein a stainless steel insulating ring is positioned between the silica gel insulating ring and the handle of the cooking pot.

10. The glass lid fixing structure with spring loaded pinball arrangement of a cooking pot as recited in claim 1, wherein the lock is mounted onto the handle of the cooking pot by a rivet and the lock rotates in axial orientation.
